(19) United States
(12) Patent Application Publication
(10) Pub. No.: US 2019/0251201 A1
(43) Pub. Date: Aug. 15, 2019

(54) INFORMATION SEARCHING SYSTEM AND INFORMATION SEARCHING METHOD

(71) Applicant: Hitachi, Ltd., Tokyo (JP)

(72) Inventors: Kentaro CHIGUSA, Tokyo (JP); Masashi TSUCHIDA, Tokyo (JP)

(21) Appl. No.: 16/140,683

(22) Filed: Sep. 25, 2018

(30) Foreign Application Priority Data
Feb. 9, 2018 (JP) 2018-021605

(51) Int. Cl. G06F 17/30

(52) U.S. Cl. CPC G06F 17/30696; G06F 17/30011; G06F 17/30663; G06F 17/30707

(57) ABSTRACT

An information searching system 1 includes a conversation-history storage unit T11 configured to store conversation histories for inquiries, a conversation-history acquisition unit P132 configured to acquire, from the conversation-history storage unit T11, a predetermined conversation history corresponding to a search query based on input information, a search-query amendment unit P114 configured to amend the search query on the basis of the predetermined conversation history, and a searching unit P115 configured to search, on the basis of the amended search query, the conversation histories stored in the conversation-history storage unit T11 and output a search result.

### BACKGROUND

The present invention relates to an information searching system and an information searching method.

In a call center or the like that answers inquiries from customers, customer handling results are recorded. When a new inquiry is received, an answerer searches similar cases in the past and answers the inquiry referring to a result of the search. For the search of cases in the past, besides full-text search for searching a case including a designated keyword, concept search for searching a case including a document similar to an inquiry text is used.

As one related art (Japanese Patent Laid-Open No. 2010-211563), it is known that “A questioner inputs a question document to a Q&A site of a Q&A system and an answerer inputs an answer document corresponding to the question. Thereafter, a document analysis is multiply performed targeting not only the question document but also the answer document created by the answerer having relatively elaborate knowledge concerning a question event to create a searching index. A searching algorithm is executed using the searching index to perform search processing on a document group included in a database. Consequently, even if a best answer is not directly obtained from the answer document, a useful document latent in the database can be extracted”.

As another related art (Japanese Patent Laid-Open No. 11-143902), it is known that “In a method including a step of storing, as an appearance frequency file, an appearance frequency of a characteristic character string, which is present in a text in a text database, in the text, a step of extracting the characteristic character string from a text designated by a user, and a step of counting an appearance frequency of the characteristic character string in the text designated by the user, a similarity degree to the text designated by the user is calculated using the appearance frequency file and the appearance frequency in the text designated by the user, and a document is searched using the calculated similarity degree”.

As still another related art (Japanese Patent Laid-Open No. 2010-9471), there is known “A question/answer searching system including a case database in which cases including pairs of question sentences and answer sentences are stored and narrow-down keyword selecting means for calculating importance degrees of keywords included in a question sentence of a case using similarity degrees of the answer sentences paired with the question sentences and selecting, on the basis of the importance degrees, from the keywords, a narrow-down keyword for narrowing down answers to an inquiry text”.

### SUMMARY

In the related arts, an answer document similar to a question sentence is only extracted. Search is not performed considering conversation histories for question sentences present before the question sentence. In the case of relatively simple content, the search sometimes ends through one question and one answer to the question. However, for example, in the case of complicated content or when segmentation of a situation is difficult, an answerer and a questioner need to exchange questions and answers many times.

When information such as question sentences and answer sentences is exchanged a plurality of times between the questioner and the answerer, information included in a question sentence in the past sometimes lacks in the latest question sentence. For example, information indicating a background, a prerequisite, or a progress of a question target matter such as a name of a system in which a problem occurs or a situation in which the problem occurs lacks. In this case, a person in charge cannot search for an appropriate answer unless the person in charge finds out a history in the past concerning the matter and creates a search query considering the history.

The present invention has been devised in view of the above problems, and an object of the present invention is to provide an information searching system and an information searching method that can improve efficiency of information search and convenience of use.

In order to solve the problems, an information searching system according to an aspect of the present invention is an information searching system that searches information, the information searching system including: a conversation-history storage unit configured to store conversation histories for inquiries; a conversation-history acquisition unit configured to acquire, from the conversation-history storage unit, a predetermined conversation history corresponding to a search query based on input information; a search-query amendment unit configured to amend the search query on the basis of the predetermined conversation history; and a searching unit configured to search, on the basis of the amended search query, a conversation history stored in the conversation-history storage unit and output a search result.

According to the present invention, the search query can be amended using the predetermined conversation history corresponding to the search query. Therefore, the search query can be automatically supplemented using the conversation history. As a result, efficiency of information search and convenience of use are improved.

### BRIEF DESCRIPTION OF THE DRAWINGS

FIG. 1 is an overall configuration diagram of a case inquiry system;

FIG. 2 is a functional configuration diagram of a search execution unit of the case inquiry system;

FIG. 3 is a flowchart for explaining processing of the search execution unit;

FIG. 4 is a flowchart for explaining processing of a search-sentence reception unit;

FIG. 5 is a flowchart for explaining processing of a document searching unit;

FIG. 6 is a flowchart for explaining processing of a conversation-history acquisition unit;

FIG. 7 is a flowchart for explaining processing of a query amendment unit;

FIG. 8 is a flowchart for explaining processing of a conversation-history-text searching unit;

FIG. 9 is a flowchart for explaining processing of a search-result display unit;

FIG. 10 is a flowchart for explaining processing of a result reranking unit;

FIG. 11 is a flowchart for explaining processing of a usefulness-information registration unit;

FIG. 12 is an explanatory diagram showing the configuration of a conversation-history storage unit;

FIG. 13 is an explanatory diagram following FIG. 12;

FIG. 14 is an explanatory diagram showing the configuration of a conversation-history-text storage unit;

FIG. 15 is an explanatory diagram following FIG. 14;

FIG. 16 is an explanatory diagram of a search query before amendment;

FIG. 17 is an explanatory diagram of the search query after amendment;

FIG. 18 is an explanatory diagram showing the configuration of a handling-code storage unit;

FIG. 19 is an explanatory diagram showing the configuration of a usefulness-information storage unit;

FIG. 20 is an explanatory diagram showing the configuration of a user-attribute storage unit;

FIG. 21 is an explanatory diagram showing a screen before search;

FIG. 22 is an explanatory diagram showing a screen on which a search result is displayed;

FIG. 23 is an explanatory diagram showing a screen on which details of the search result are displayed;

FIG. 24 is an explanatory diagram showing another screen on which the details of the search result are displayed;

FIG. 25 is an explanatory diagram showing the configuration of a handling-code storage unit according to a second embodiment;

FIG. 26 is a flowchart for explaining processing of a query amendment unit;

FIG. 27 is an explanatory diagram showing the configuration of a search query after amendment;

FIG. 28 is an overall configuration diagram of a case searching system according to a third embodiment;

FIG. 29 is an overall configuration diagram of a case searching system according to a fourth embodiment;

FIG. 30 is an explanatory diagram showing the configuration of a conversation-history storage unit; and

FIG. 31 is an explanatory diagram showing the configuration of a handling-code storage unit.

### DETAILED DESCRIPTION OF THE EMBODIMENTS

Embodiments of the present invention are explained below with reference to the drawings. In the embodiments, as explained below, a conversation history (a behavior history) at the time when a person in charge (an answerer) performs search is acquired and saved. The saved conversation history is used for the next and subsequent search.

That is, in the embodiments, information exchange between the person in charge and a customer (a questioner) is stored as a conversation history. When the conversation history is searched, a search query is amended using the stored conversation history. The conversation history is searched using the amended search query.

Consequently, according to the embodiments, a conversation history in the past serving as a reference of a problem solution can be efficiently and accurately searched using the search query amended by a conversation history of a present matter. Therefore, according to the embodiments, the number of times of information exchange between the person in charge and the customer can be reduced. A time required for performing the information exchange once can be reduced. The number of handleable matters per unit time of the person in charge can be increased.

In the following explanation, information in the embodiments is explained using representations such as “aaa table”, “aaa list”, and “aaa DB (Database)” (aaa is any character string). However, these kinds of information do not always need to be saved in the forms and may be represented in forms other than data structures such as a table, a list, a DB, and a queue. Therefore, the “aaa table”, the “aaa list”, the “aaa DB”, and the like are sometimes referred to as “aaa information” in order to indicate that the information does not depend on the data structure.

When contents of the information are explained, representations such as “identification information”, “identifier”, “appellation”, “name”, and “ID (IDentification)” are used. These representations can be replaced with one another.

In the information illustrated in the embodiments, not-shown fields may be included, several data fields may be divided and registered in different DBs, or several data fields may be absent.

In processing flows illustrated in the embodiments, not-shown processing steps may be included, several processing steps may be absent, or execution order of several processing steps may be changed.

In the following explanation, a “computer program” is used as a subject. However, the computer program is executed by a processor to perform decided processing while using a memory and a communication port (a communication control device). Therefore, the processor may be used as a subject in the explanation. Processing disclosed using the computer program as the subject may be processing performed by a computer or an information processing apparatus such as a management server. Apart or the entire computer program may be realized by dedicated hardware.

Various computer programs may be installed in computers by a program distribution server or a computer-readable storage medium. In this case, the program distribution server includes a processor and a storage resource. The storage resource further stores a distribution program and a distribution target computer program. The processor executes the distribution program, whereby the processor of the program distribution server distributes the distribution target computer program to other computers.

Note that the present invention is not limited to the embodiments explained below and includes various modifications and equivalent configurations within the gist of the appended claims. For example, the embodiments are explained in detail in order to clearly explain the present invention. The embodiments are not always limited to embodiments including all explained components.

A part of components in a certain embodiment may be replaced with components in other embodiments. Components in other embodiments may be added to components in a certain embodiment. Other components may be added to, deleted from, or replaced with a part of components of the embodiments.

Components, functions, processing units, processing means, and the like explained below may be realized by hardware, such as by designing a part or all of the components, the functions, the processing units, the processing means, and the like as integrated circuits. The components, the functions, the processing units, the processing means, and the like may be realized by software by the processor interpreting and executing computer programs for realizing the functions.

Information such as computer programs, tables, and files for realizing the functions only has to be stored in a storage device such as a memory, a hard disk, or an SSD (Solid State Drive) or a recording medium such as an IC card, an SD card, a DVD, a Blue Ray Disk, or another optical disk. Not all of the information needs to be stored in the same recording medium. Several computer programs, tables, and files may be stored in different storage media or may be stored in storage media of not-shown apparatuses connected via a communication network.

Control lines and information lines considered to be necessary for explanation are shown. Not all of control lines and information lines necessary for implementation are shown. Actually, almost all the components may be considered to be coupled to one another.

The computer includes an input/output device. As examples of the input/output device, a display, a keyboard, a pointer device, a tablet terminal, and a smartphone are conceivable. However, the input/output device may be a device other than these devices. A serial interface or an Ethernet interface may be used as an input/output device instead of the input/output device. A computer for display including a display, a keyboard, or a pointer device may be coupled to the interface. Information for display may be transmitted to the computer for display and information for input may be received from the computer for display to perform display in the computer for display. The input and the display in the input/output device may be substituted by receiving an input. Note that the interface is sometimes described as I/F below.

The computer includes a communication I/F. As an example of the communication I/F, a LAN (Local Area Network) connection terminal, a SAN (Storage Area Network) connection terminal, and a connecting apparatus of wireless communication are conceivable. However, the communication I/F may be a device other than these devices. As the communication network, a wired network and a wireless network are conceivable. The communication network may be either the wired network or the wireless network.

### First Embodiment

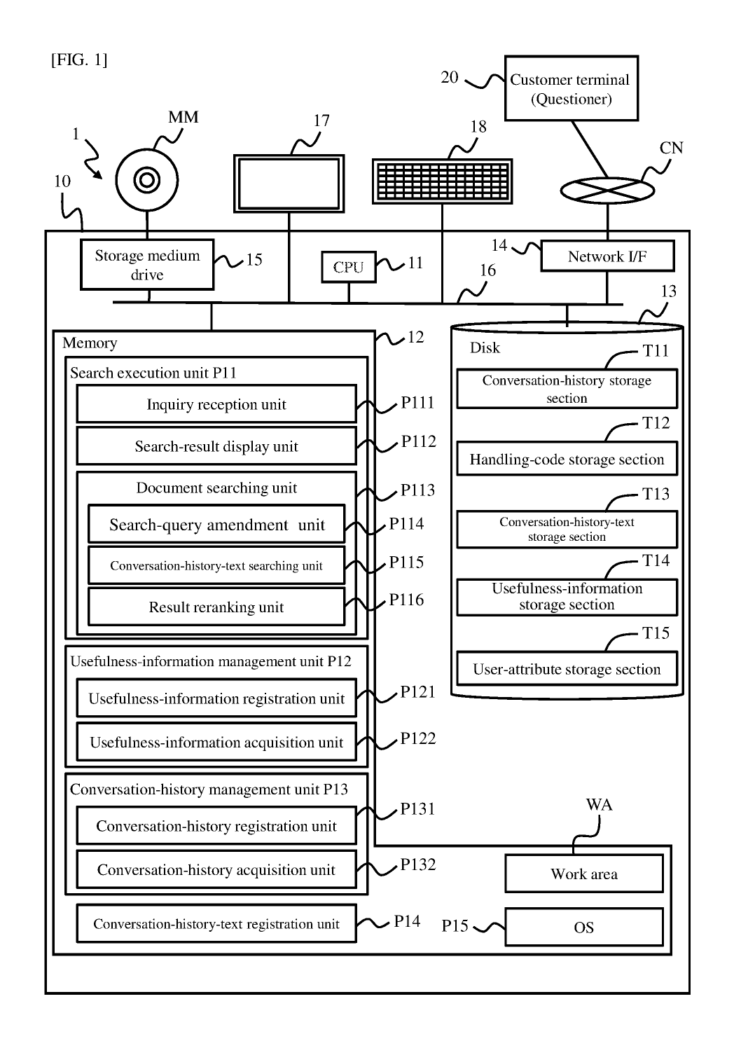

A first embodiment is explained with reference to FIGS. 1 to 24. First, definitions of terms used in this embodiment are explained.

“Inquiry” means information such as a question sentence or failure information sent from a questioner to a call center or the like. The “inquiry” includes not only a question sent first but also an additional question and information related to questions sent in a series of handling.

“Inquiry text” means document information in which content of an inquiry is written.

“Handling” means exchanging information for a person in charge, who uses a case searching system, to find a final answer to a question from a questioner, who is a customer. The “handling” includes, for example, confirmation of a situation with the customer, a request for supplementary information, and transfer of the question to a related department.

“Matter” means an inquiry unit from the customer. First information exchange to information exchange resulting in problem solution are treated as a set.

“Matter number” means a number uniquely allocated to each matter.

“Query” means information concerning a search expression generated on the basis of a question sentence input to the case searching system by the person in charge. The “query” is referred to as search query as well.

“Case” means a completed matter.

“Conversation history” means history information in which all contents of information exchange between customers (questioners) and persons in charge and related departments concerning inquiries in the past are recorded.

“Conversation history text” means information in which conversation histories are collected as one text file. The “conversation history text” is created for each matter.

“Material” means a general term of information such as a log or an error message output by a system or an application when a failure occurs.

FIG. 1 shows an overall configuration of a case searching system 1, which is an example of an “information searching system” according to the first embodiment.

The case searching system 1 includes, for example, a case searching server 10, which is an example of a “computer”, an information output apparatus 17, and an information input apparatus 18. The case searching system 1 is connected to a terminal 20 of a questioner, who is a customer, via a communication network CN. In the following explanation, the questioner is referred to as customer as well. The case searching system 1 is used from, for example, a call center. The case searching system 1 can be provided in a facility such as the call center (so-called on-premise). Alternatively, the case searching system 1 may be disposed on a communication network and configured to be used from one or a plurality of call centers (so-called cloud).

The information output apparatus 17 is, for example, a display apparatus. The information output apparatus 17 is not limited to the display apparatus and may include another information output apparatus such as a printer, a sound synthesizing apparatus, or a robot. The information input apparatus 18 is a pointing device such as a keyboard or a mouse. The information input apparatus 18 is not limited to the keyboard and may include another information input apparatus such as a sound recognition apparatus, a visual-line detection apparatus, or an operation detection apparatus. The information output apparatus 17 and the information input apparatus 18 may be integrated like a touch panel.

An operation terminal (not shown in FIG. 1) coupled to the case searching server 10 can be used as the information output apparatus 17 and the information input apparatus 18. The case searching system 1 can handle inquiries (referred to as questions as well) from a plurality of customers. A plurality of persons in charge can handle the respective customers using the case searching system 1.

A customer can access the case searching system 1 using the terminal 20 and ask a question via an electronic mail or a chat. The case searching system 1 is not limited to information exchange by characters and may use a voice recognition system to thereby automatically convert voice of the customer or the person in charge into characters and store the characters as an electronic file. Although not shown in FIG. 1, a plurality of terminals 20 can simultaneously access the case searching server 10 via the communication network CN.

The configuration of the case searching server 10 is explained. The case searching server 10 includes, for example, a microprocessor (CPU) 11, a memory 12, an auxiliary storage apparatus (in FIG. 1, a disk) 13, a network interface (I/F) 14, and a storage medium drive 15. The circuits 11 to 15 are coupled to one another by a bus 16.

The microprocessor 11 executes computer programs explained below stored in the memory 12 to thereby realize functions of the case searching server 10. In executing the computer program, the microprocessor 11 uses information T11 to T15 explained below stored in the auxiliary storage apparatus 13.

The memory 12 is configured from, for example, a ROM (Read Only Memory) and a RAM (Random Access Memory). In the memory 12, for example, computer programs such as a search execution unit P11, a usefulness-information management unit P12, a conversation-history management unit P13, and a conversation-history-text registration unit P14 and an operating system (OS) P15 are stored. In the memory 12, a work area WA used by the microprocessor 11 is also provided.

The search execution unit P11 is a computer program group for performing search. The search execution unit P11 includes, for example, an inquiry-text reception unit P111 that receives an inquiry text, a search-result display unit P112 that causes the customer terminal 20 and/or the information output apparatus 17 to display a search result, and a document searching unit P113 that searches a conversation history.

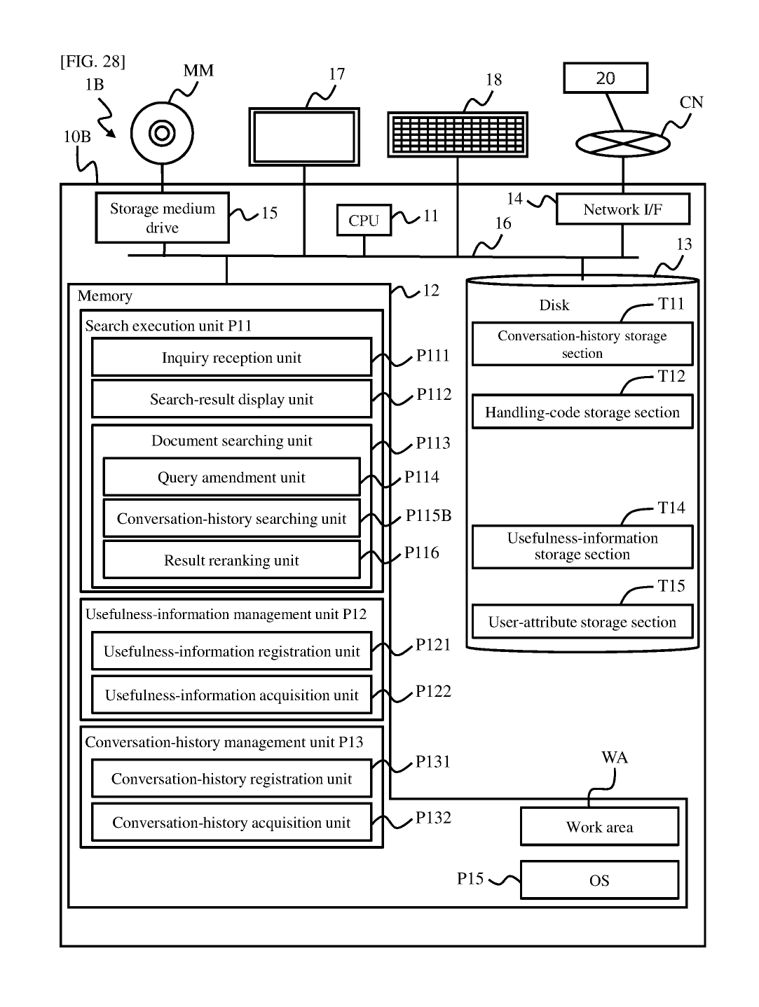

The document searching unit P113 includes a query amendment unit P114 functioning as a “search-query amendment unit” that amends a search query, a conversation-history-text searching unit P115 that searches a conversation history text, and a result reranking unit P116. The conversation-history-text searching unit P115 is an example of a “searching unit” like a conversation-history searching unit P115B explained below with reference to FIG. 28.

The usefulness-information management unit P12 is a computer program group that manages usefulness information obtained by evaluating whether a conversation history is useful. The usefulness-information management unit P12 includes, for example, a usefulness-information registration unit P121 that registers the usefulness information in the case searching system 1 in association with the conversation history and a usefulness-information acquisition unit P122 that acquires the usefulness information registered in association with the conversation history.

The conversation-history management unit P13 is a computer program group that manages the conversation history. The conversation-history management unit P13 includes a conversation-history registration unit P131 that registers the conversation history in the case searching system 1 and a conversation-history acquisition unit P132 that acquires the registered conversation history.

The auxiliary storage apparatus 13 is configured as a nonvolatile large-capacity storage apparatus such as a hard disk or a flash memory device. The auxiliary storage apparatus 13 stores, for example, a conversation-history storage unit T11, a handling-code storage unit T12, a conversation-history-text storage unit T13, a usefulness-information storage unit T14, and a user-attribute storage unit T15.

The conversation-history storage unit T11 stores the conversation history received from the conversation-history registration unit P131. The handling-code storage unit T12 stores code information associated with the conversation history. The conversation-history-text storage unit T13 stores the conversation history text generated by the conversation-history-text registration unit P14. The usefulness-information storage unit T14 stores the usefulness information received from the usefulness-information registration unit P121. The user-attribute storage unit T15 stores attributes of a person in charge who answers referring to the conversation history.

The network interface 14 is an interface connected to the communication network CN to perform communication. The case searching server 10 is connected from the network interface 14 to the customer terminal 20 via the communication network CN.

The storage medium drive 15 is an apparatus that reads and writes an external storage medium MM such as a hard disk or a flash memory. Computer programs P11 to P15 or information T11 to T15 fixed in the external storage medium MM can be read from the storage medium drive 15 and stored in the memory 12 or the auxiliary storage apparatus 13. Alternatively, at least a part of the computer programs P11 to P15 or the information T11 to T15 stored in the memory 12 or the auxiliary storage apparatus 13 can be written and fixed in the external storage medium MM using the storage medium drive 15.

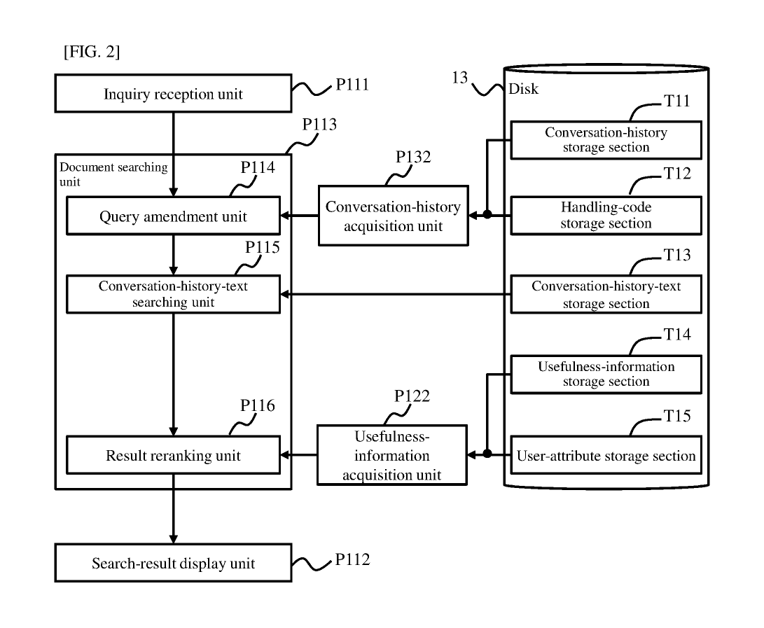

FIG. 2 shows a functional configuration of the search execution unit P11. When receiving an inquiry from a customer through information transmitting means such as an electronic mail or a chat, a person in charge inputs an inquiry text to the case searching server 10 from the information input apparatus 18.

When receiving the inquiry text (which can be referred to as first searching sentence as well) serving as “input information” from the person in charge, the inquiry-text reception unit P111 of the search execution unit P11 passes the inquiry text to the query amendment unit P114 of the document searching unit P113.

According to a request from the query amendment unit P114, the conversation-history acquisition unit P132 acquires a predetermined conversation history corresponding to the inquiry text from the conversation-history storage unit T11 and acquires code information associated with the predetermined conversation history from the handling-code storage unit T12. The conversation-history acquisition unit P132 sends the acquired predetermined conversation history and the acquired code information to the query amendment unit P114. The predetermined conversation history is, for example, a conversation history having the same matter number as a matter number of the inquiry text.

The query amendment unit P114 amends, on the basis of the predetermined conversation history and the code information received from the conversation-history acquisition unit P132, a search query (an initial search query) obtained from the input inquiry text. As explained in detail below, the query amendment unit P114 amends the initial search query by adding the predetermined conversation history to the initial search query and passes the amended search query to the conversation-history-text searching unit P115.

The conversation-history-text searching unit P115 searches a conversation history text stored in the conversation-history-text storage unit T13 using the search query after amendment and outputs a result of the search. The conversation history text is a document obtained by coupling texts of a related plurality of conversation histories as one file.

The result reranking unit P116 functioning as a “search-result rearrangement unit” evaluates the search result of the conversation-history-text searching unit P115 on the basis of the usefulness information received by the usefulness-information acquisition unit P122 from the usefulness-information storage unit T14 and rearranges the conversation histories in descending order of values of the usefulness information.

The values of the usefulness information can be changed according to attributes of a user (the person in charge) who evaluates the conversation histories. For example, when an experienced person in charge evaluates that a conversation history is “useful reference”, a value of usefulness information of the conversation history can be set high. Therefore, the usefulness-information acquisition unit P122 acquires usefulness information for each predetermined conversation history from the usefulness-information storage unit T14 and acquires attributes (a position, a grade, a skill level, and the like) of the user who sets the usefulness information (the person in charge who refers to the conversation history) from the user-attribute storage unit T15.

The usefulness-information acquisition unit P122 can calculate, for example, among the usefulness information set in the predetermined conversation history, the number of pieces of usefulness information set by a user having a predetermined skill level and a predetermined grade and use a value of the number of pieces of usefulness information as a value of the usefulness information. Alternatively, the usefulness-information acquisition unit P122 can also respectively multiplies the usefulness information set in the predetermined conversation history by values decided from the user attributes and use a total value of the multiplied values as a value of the usefulness information.

When receiving the search result after the rearrangement from the result reranking unit P116, the search-result display unit P112 transmits the search result to the customer terminal 20 and causes the customer terminal 20 to display the search result. The search-result display unit P112 may output the search result to the information output apparatus 17.

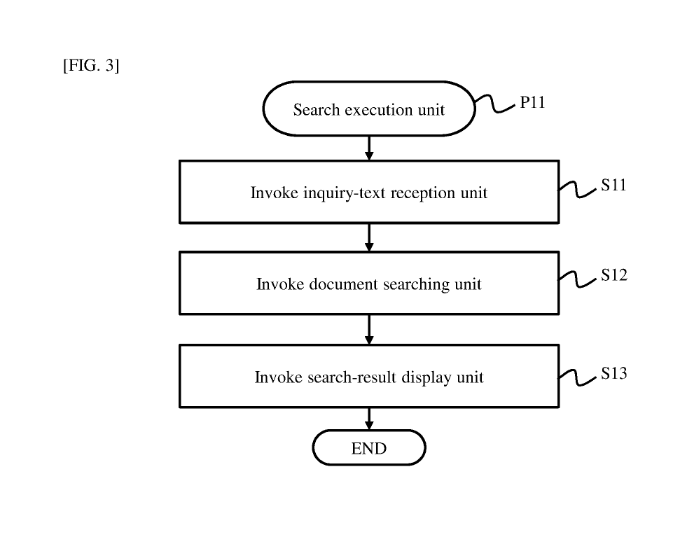

FIG. 3 is a flowchart for explaining processing of the search execution unit P11. As explained above, the search execution unit P11 uses the inquiry text received by the inquiry-text reception unit P111 (S11), causes the document searching unit P113 to search the conversation history text (S12), and causes the search-result display unit P112 to display a result of the search (S13).

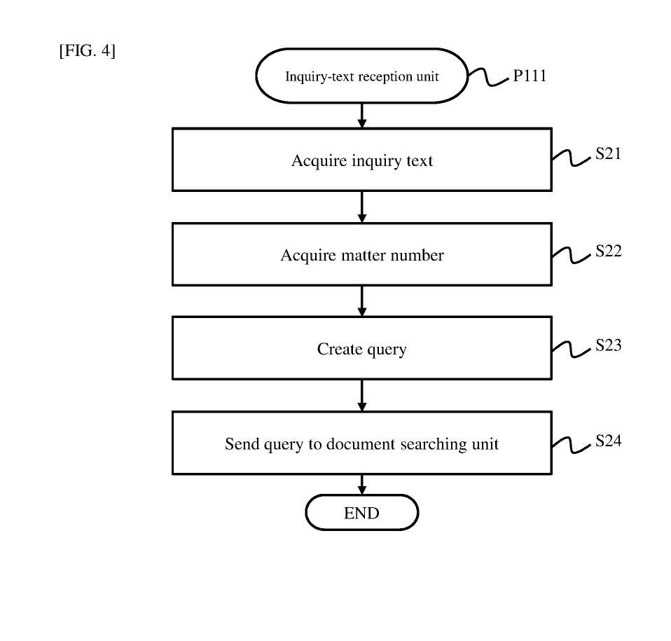

FIG. 4 is a flowchart for explaining processing of the inquiry-text reception unit P111. The inquiry-text reception unit P111 acquires an inquiry text input from the information input apparatus 18 (S21). The inquiry-text reception unit P111 acquires a matter number of the acquired inquiry text (S22).

The person in charge may manually input the matter number together with the inquiry text. Alternatively, the inquiry-text reception unit P111 may search a conversation history using the inquiry text as a key and acquire a matter number of a conversation history coinciding with the inquiry text. Further, the inquiry-text reception unit P111 may display a list of matter numbers of conversation histories coinciding with the inquiry text and cause the person in charge to select a matter number out of the matter numbers.

The inquiry-text reception unit P111 creates a query used for first search (an initial search query) from the input inquiry text and the matter number (S23). The inquiry-text reception unit P111 transmits the created query to the document searching unit P113 (S24).

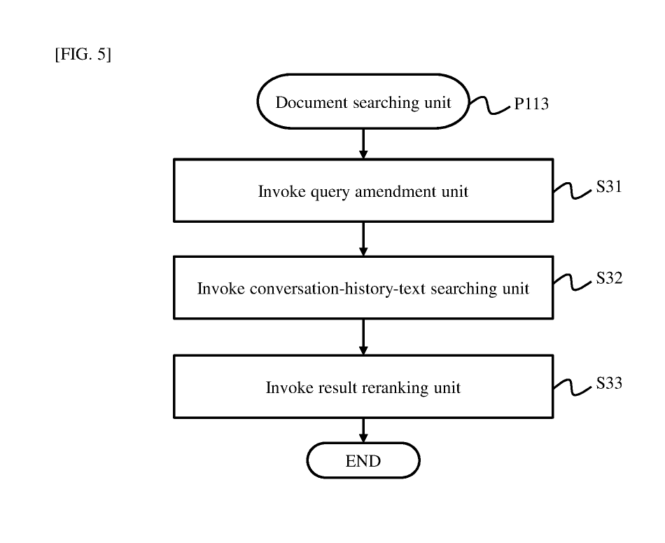

FIG. 5 is a flowchart for explaining processing of the document searching unit P113. The document searching unit P113 causes the query amendment unit P114 to amend the initial search query received from the inquiry-text reception unit P111 (S31).

The document searching unit P113 causes the conversation-history-text searching unit P115 to search a conversation history text using the query after amendment (S32). The document searching unit P113 causes the result reranking unit P116 to rearrange search results on the basis of the values of the usefulness information (S33).

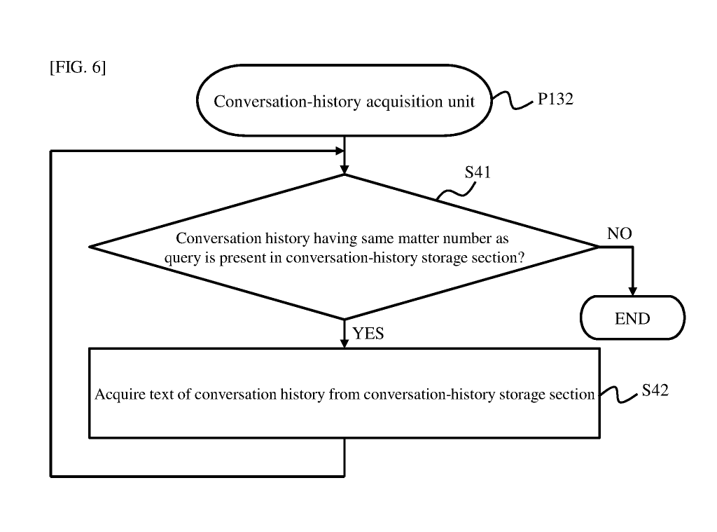

FIG. 6 is a flowchart for explaining processing of the conversation-history acquisition unit P132. The conversation-history acquisition unit P132 determines whether a conversation history (a predetermined conversation history) having the same matter number as the matter number of the initial search query is present in the conversation-history storage unit T11 (S41). That is, the conversation-history acquisition unit P132 confirms whether a history of a matter having the same matter number as the matter number of the initial search query is stored in the conversation-history storage unit T11.

If finding the conversation history having the same matter number as the matter number of the initial search query (YES in S41), the conversation-history acquisition unit P132 acquires a text (a portion excluding bibliographic matters) of the conversation history from the conversation-history storage unit T11 (S42). If the conversation history having the same matter number as the matter number of the initial search query is not successfully found (NO in S41), this processing ends.

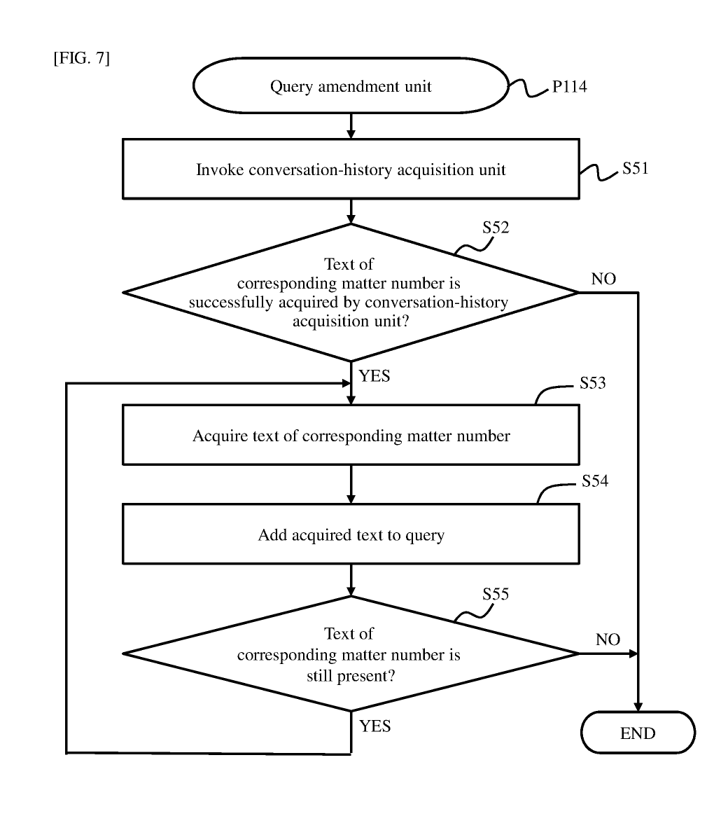

FIG. 7 is a flowchart for explaining processing of the query amendment unit P114. The query amendment unit P114 passes the matter number of the initial search query to the conversation-history acquisition unit P132 and invokes the conversation-history acquisition unit P132 (S51).

The query amendment unit P114 determines whether the conversation-history acquisition unit P132 successfully acquires the conversation history having the same matter number (in FIG. 7, corresponding matter number) as the matter number of the initial search query (S52). If the conversation history having the corresponding matter number is successfully acquired by the conversation-history acquisition unit P132 (YES in S52), the query amendment unit P114 acquires a text of the conversation history having the corresponding matter number (S53).

The query amendment unit P114 adds the text acquired in step S53 to the initial search query to thereby amend the initial search query (S54). The query amendment unit P114 determines whether another text having the corresponding matter number is still present (S55). If the other text is present (YES in S55), the query amendment unit P114 returns to step S53 and further adds the other text to the search query (S54).

If the conversation history having the corresponding matter number is unsuccessfully acquired (NO in S52) and if a text (another text) of another conversation history having the corresponding matter number is absent (NO in S55), the processing ends.

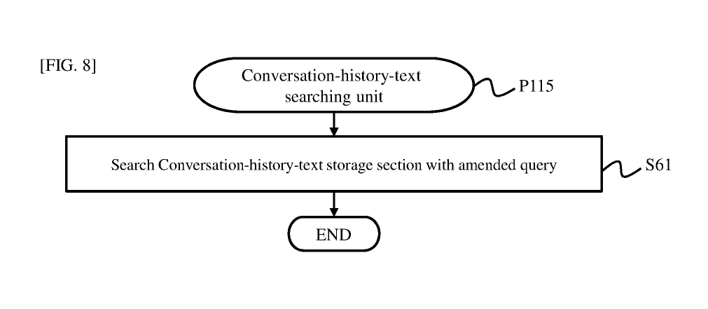

FIG. 8 is a flowchart for explaining processing of the conversation-history-text searching unit P115. For example, the conversation-history-text searching unit P115 conceptually searches the conversation-history-text storage unit T13 using the query amended by the query amendment unit P114, sorts matter numbers of hit conversation history texts in descending order of scores, and returns the matter numbers (S61).

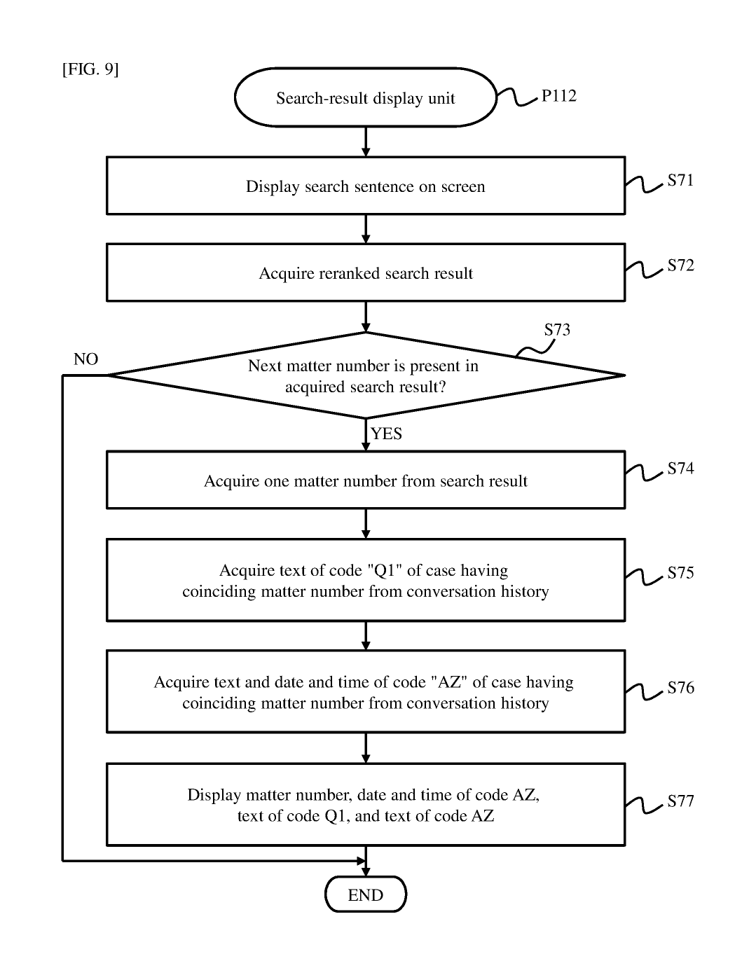

FIG. 9 is a flowchart for explaining processing of the search-result display unit P112. The search-result display unit P112 displays a searching sentence on a screen (S71) and acquires a reranked search result (S72).

The search-result display unit P112 determines whether the next matter number is present in the search result acquired in step S72 (S73). If the next matter number is absent (NO in S73), the search-result display unit P112 ends this processing.

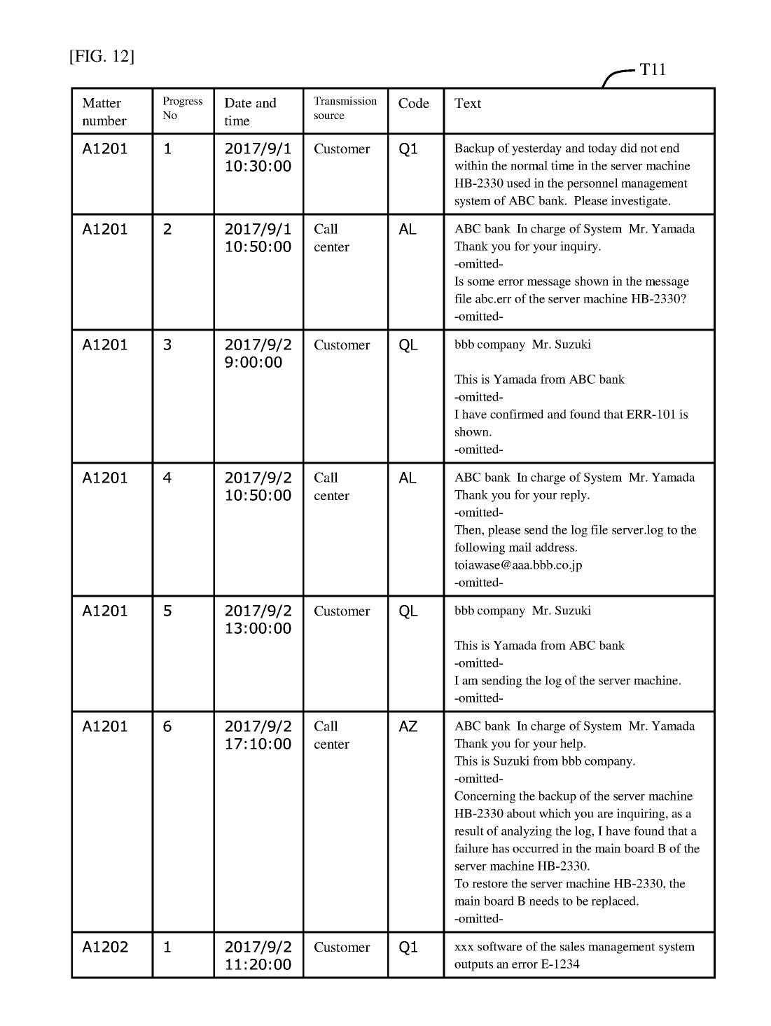

If determining that the next matter number is present (YES in S73), the search-result display unit P112 acquires one matter number out of the search result acquired in step S72 (S74). The search-result display unit P112 refers to the conversation-history storage unit T11 and acquires a text of a code “Q1” out of matters coinciding with the matter number acquired in step S74 (S75). The code “Q1” means “an inquiry from the customer” as shown in FIG. 12.

Further, the search-result display unit P112 refers to the conversation-history storage unit T11 and acquires a text of a code “AZ” and date and time of the text out of the matters coinciding with the matter number acquired in step S74 (S76). The code “AZ” means “a final answer to the customer”.

The search-result display unit P112 displays, on the screen, the matter number, the date and time corresponding to the code “AZ”, the text of the code “Q1”, and the text of the code “AZ” (S77).

A creation procedure of the conversation-history storage unit T11 is explained.

(Procedure 1) A conversation history is created in a job of a call center or the like.

(Procedure 2) When receiving a first report of an inquiry from a customer, a person in charge (an answerer) of the call center or the like logs on to the case searching system 1 using a user ID and registers inquiry content in the case searching system 1. For example, the person in charge sets the content of the inquiry from the customer as a text and registers a handling code (see FIG. 12) and a transmission source together.

(Procedure 3) The case searching system 1 invokes the conversation-history registration unit P131 and cause the conversation-history storage unit T11 to store a matter number, a progress No., and date and time together. As the “matter number”, a number obtained by adding “1” to the immediately preceding number is adopted. That is, the conversation-history registration unit P131 adds “1” to an immediately preceding registered matter number for numbering. 1 is set in the “progress No.”. Registration date and time is set in the “date and time”. The registration date and time can be acquired from a timer in a computer. Note that when the inquiry from the customer is sent by an electronic mail or the like, the inquiry content may be automatically registered in the conversation-history storage unit T11 as explained above at timing when the electronic mail is received.

(Procedure 4) When the person in charge answers the customer, confirms details with the customer, requests the customer to send materials, and sends an inquiry to a related department such as a development source department of an inquiry target product, the person in charge stores an inquiry text and a code in the conversation-history storage unit T11 using the case searching system 1 every time. In that case, the progress No. automatically increases by one at a time.

A creation procedure of the conversation-history-text storage unit T13 is explained.

(Procedure 1) A text of the conversation-history-text storage unit T13 is a document obtained by coupling texts having the same matter number among matters stored in the conversation-history storage unit T11. A document obtained by coupling texts of a series of handing histories (a conversation history text) is set as a target of a concept search by the search execution unit P11.

(Procedure 2) The conversation-history-text registration unit P14 confirms the conversation-history storage unit T11, for example, once in a day. When a matter number not stored in the conversation-history-text storage unit T13 is present and the code “AZ” is present in a matter of the matter number (i.e., a final answer to the matter is obtained), the conversation-history-text registration unit P14 couples a text of the pertinent matter number and stores the pertinent matter number and the coupled text in the conversation-history-text storage unit T13.

(Procedure 3) Note that the conversation-history-text registration unit P14 may execute the processing at any timing rather than once a day. The conversation-history-text registration unit P14 may execute the processing, for example, at timing when the code AZ is stored in the conversation-history storage unit T11. If a matter currently in progress is also added to a search target, the conversation-history-text registration unit P14 may be created neglecting a value of the code.

(Procedure 4) The conversation-history-text registration unit P14 may not be created in advance. That is, information equivalent to the conversation-history-text storage unit T13 may be created in the work area WA at timing when the search execution unit P11 executes the concept search.

(Procedure 5) In the conversation history text, not only exchange of information between the person in charge and the customer but also a technical document such as a manual or a document such as a collection of knowhow may be registered together and set as a search target. Consequently, the person in charge can access more accurate information. As a result, a handling time further decreases.

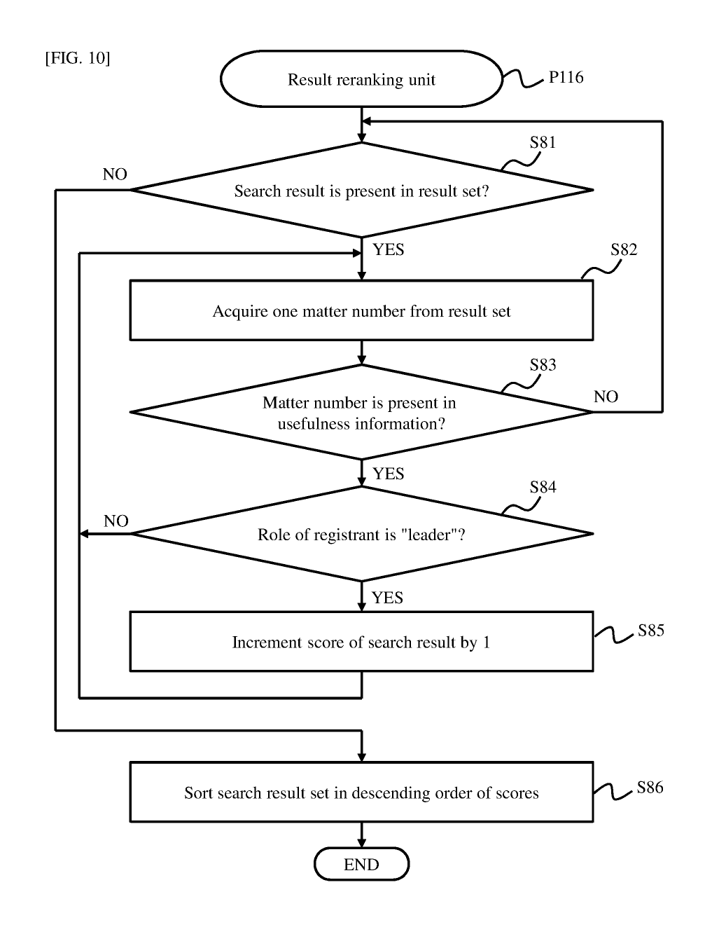

FIG. 10 is a flowchart for explaining processing of the result reranking unit P116. First, the result reranking unit P116 determines whether one or more search results are present in a result set (S81). If the one or more search results are present (YES in S81), the result reranking unit P116 proceeds to step S82. If the one or more search results are absent (NO in S81), the result reranking unit P116 proceeds to step S86 and ends this processing.

The result reranking unit P116 extracts one search result from the result set (S82) and determines whether a matter number of the acquired search result coincides with a matter number stored in the usefulness-information storage unit T14 (S83). If the matter numbers coincide (YES in S83), the result reranking unit P116 proceeds to step S84. Otherwise (NO in S83), the result reranking unit P116 returns to step S81.

The result reranking unit P116 acquires a registrant ID corresponding to the matter number of the usefulness-information storage unit T14, searches the user-attribute storage unit T15 concerning the acquired registrant ID, and determines whether a role of the registrant is a leader (S84). If the registrant is the “leader” (YES in S84), the result reranking unit P116 proceeds to step S85. Otherwise, the result reranking unit P116 returns to step S82.

Note that the result reranking unit P116 may determine the registrant not only according to the role condition but also according to a plurality of conditions connected by AND or OR. Instead of the “role”, a numerical value such as a “level” may be registered in the user-attribute storage unit T15. The result reranking unit P116 may determine, for example, whether “the level is equal to or larger than three”.

The result reranking unit P116 increments a score of the search result by one (S85) and returns to step S82.

As a result of performing the processing in this way, when it is finally determined “NO” in step S81, the result reranking unit P116 sorts a search result set in descending order of corrected scores (S86).

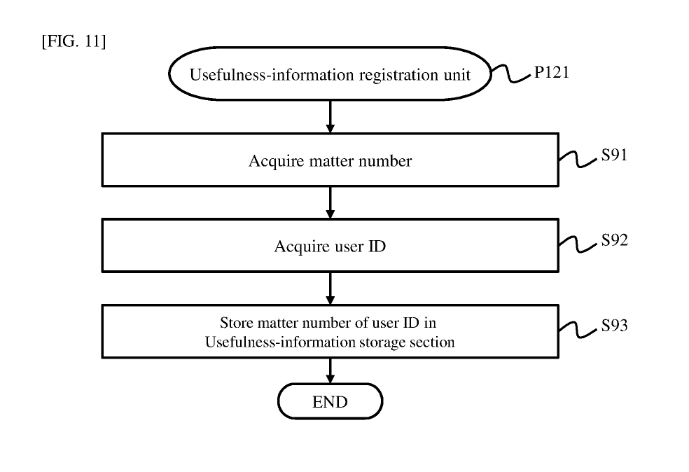

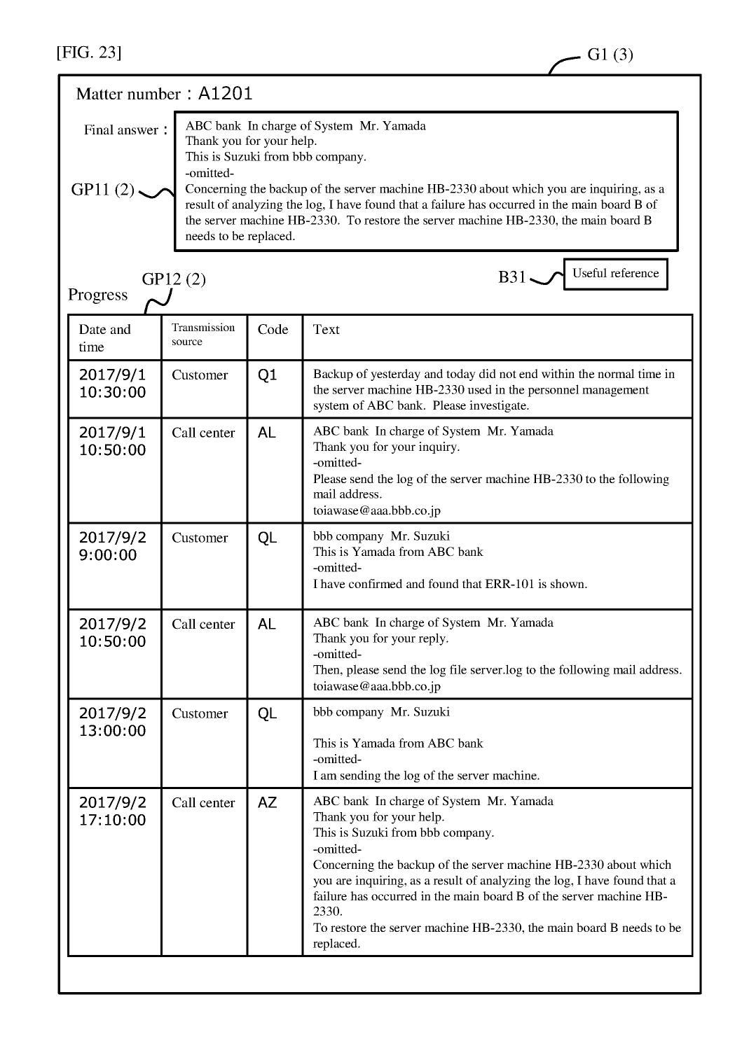

FIG. 11 is a flowchart for explaining processing of the usefulness-information registration unit P121. The usefulness-information registration unit P121 starts at timing when a “useful reference” button B31 of a case searching system screen example (detailed display) G1(3) shown in FIG. 23 is pressed.

The usefulness-information registration unit P121 acquires a matter number displayed on the search result screen (detailed display) G1(3) (S91) and acquires a user ID of a user who presses the button B31 (S91). The usefulness-information registration unit P121 causes the usefulness-information storage unit T14 to store the acquired matter number and the acquired user ID (S93).

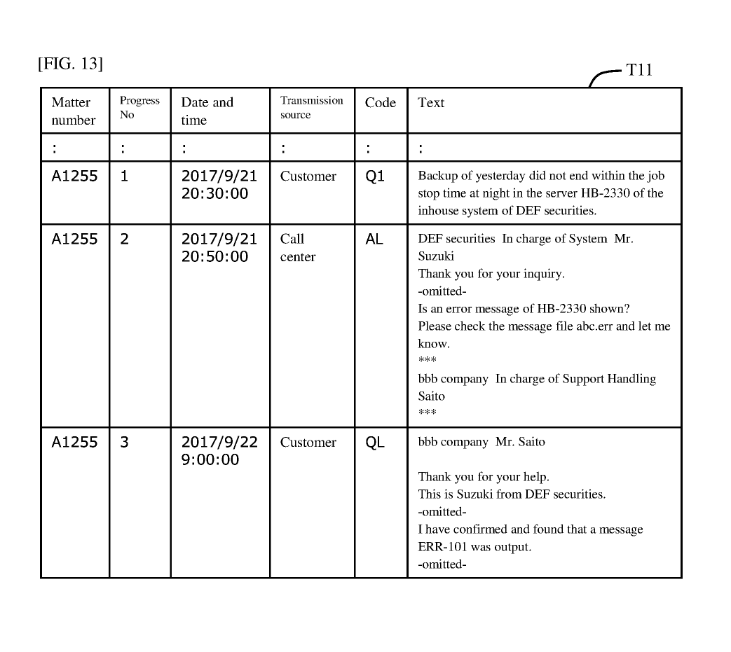

FIGS. 12 and 13 show an example of storage content of the conversation-history storage unit T11. The conversation-history storage unit T11 manages, for example, “matter number”, “progress No.”, “date and time”, “transmission source”, “code”, and “text” in association with one another. In FIG. 12, the “transmission source” is a person in charge (in FIG. 12, “call center”) or a customer.

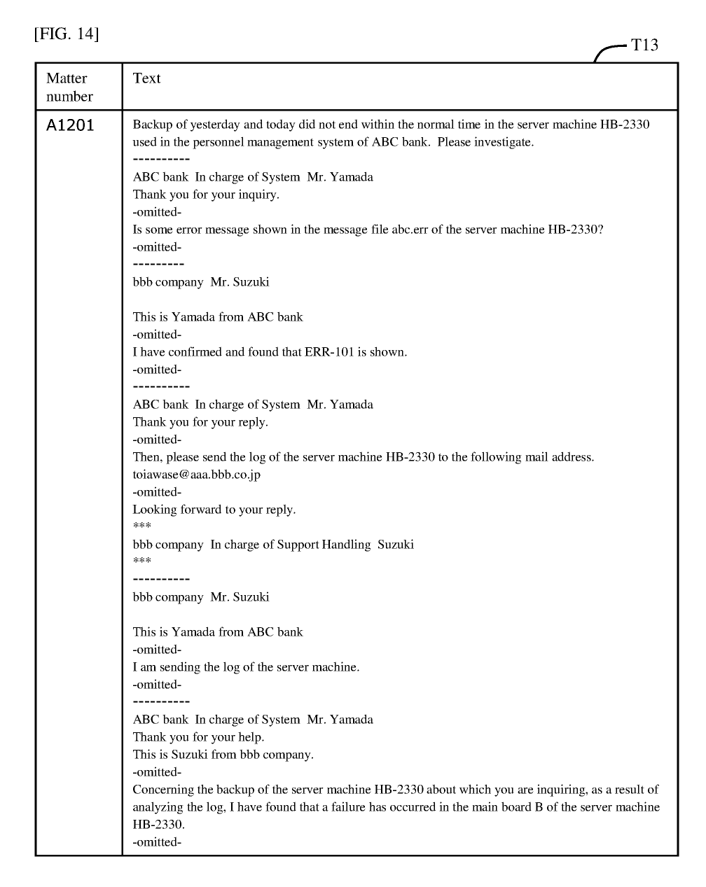

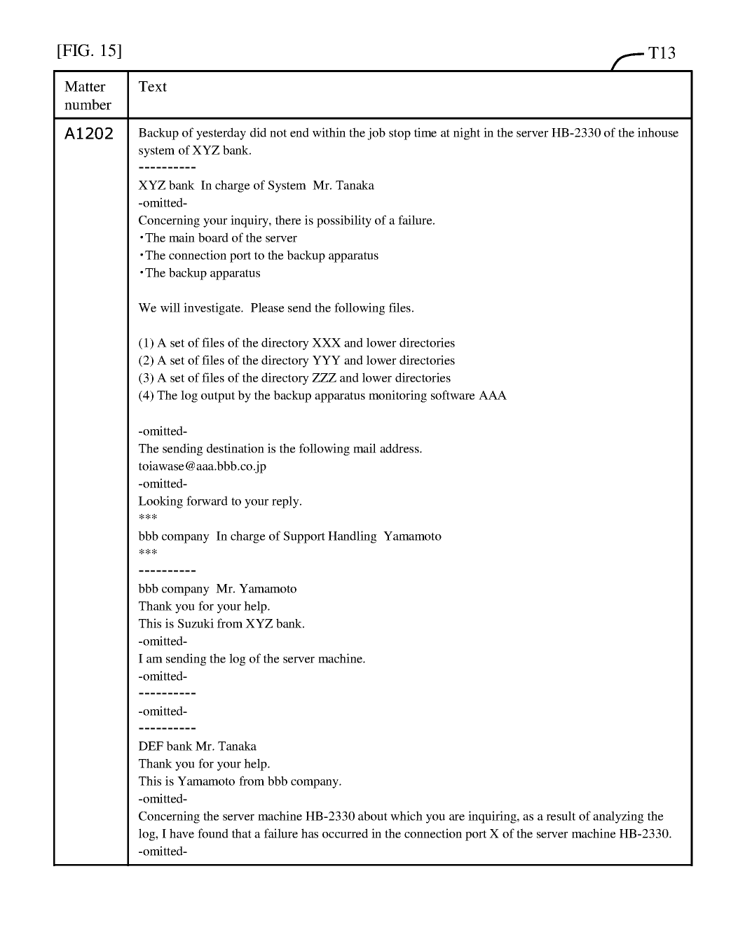

FIGS. 14 and 15 show an example of storage content of the conversation-history-text storage unit T13. A conversation history text is generated by coupling texts of conversation histories having the same matter number.

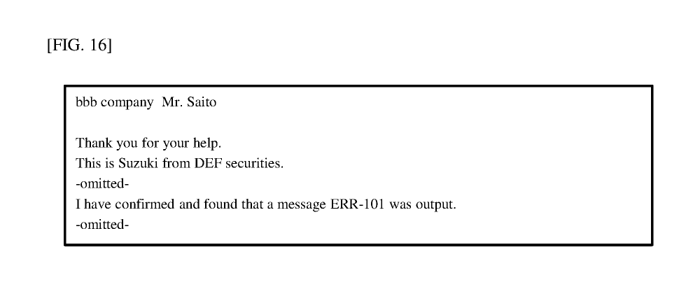

FIG. 16 shows an example of a search query before amendment.

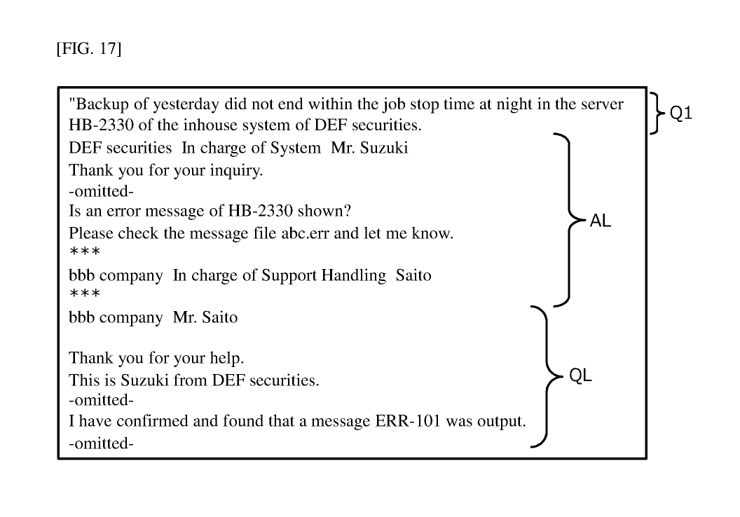

FIG. 17 shows an example of a search query after amendment. The search query before amendment includes, as shown on the lower side of FIG. 17, only information provision (a code QL) from a customer. On the other hand, the search query after amendment further includes, as shown on the upper side of FIG. 17, an inquiry (a code Q1) from the customer and an information provision request (a code AL) from a person in charge to the customer. In this way, in this embodiment, rather than searching a case in the past according to only the latest inquiry from the customer, the search query is amended by adding information extracted from a series of information in the past of the case.

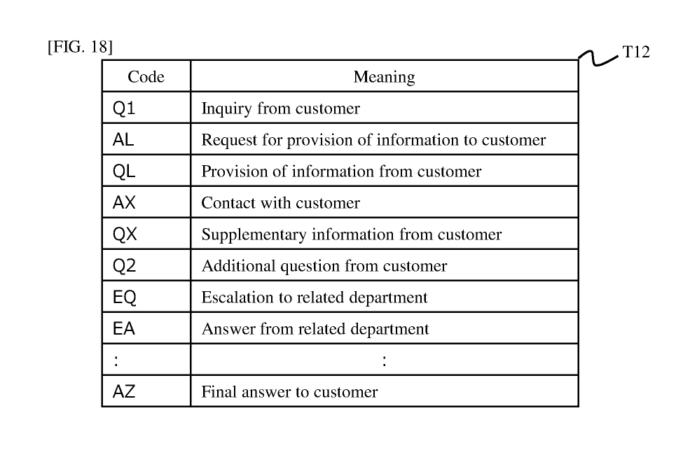

FIG. 18 shows an example of storage content of the handling-code storage unit T12. Codes are prepared in advance to classify content of a conversation history.

A code Q1 indicates an inquiry from a customer. A code AL indicates an information provision request to the customer. A code QL indicates information provision from the customer. A code AX indicates contact with the customer. A code QX indicates supplementary information from the customer. A code Q2 indicates an additional question from the customer. A code EQ indicates escalation to a related department. The escalation means an inquiry to the related department. A code EA indicates an answer from the related department. A code AZ indicates a final answer to the customer. These codes are an example. Codes having other meanings may be added. A part of the codes shown in FIG. 18 may be deleted.

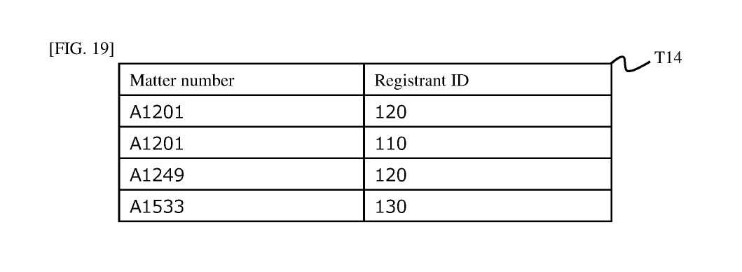

FIG. 19 shows an example of storage content of the usefulness-information storage unit T14. The usefulness-information storage unit T14 stores, for example, a matter number and a registrant ID in association with each other.

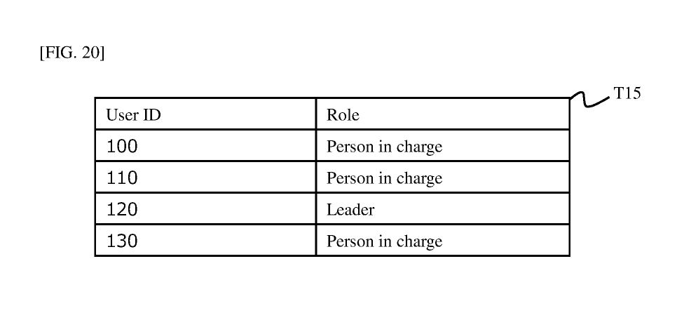

FIG. 20 shows an example of storage content of the user-attribute storage unit T15. The user-attribute storage unit T15 stores, for example, a user ID and a role in association with each other. The roll is information indicating a role of a user who uses information concerning a case in the past (a person in charge who answers a question). The role is classified into, for example, “leader” and “person in charge”. Besides, for example, attributes such as “subleader”, “supervisor”, and “observer” may be added.

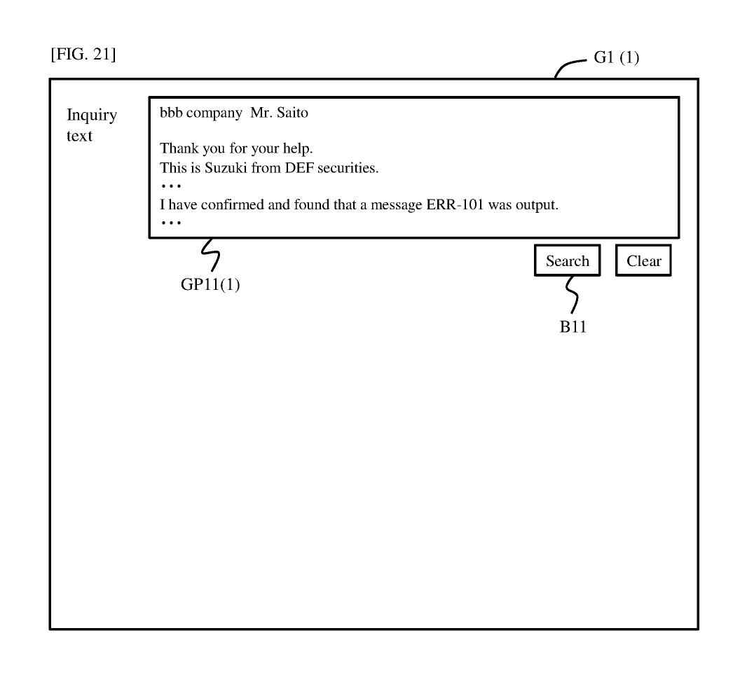

FIG. 21 shows an example before search of a case searching screen G1(1) for searching a case. The screen G1(1) includes, for example, a section GP11(1) for displaying an inquiry text and a search button B11.

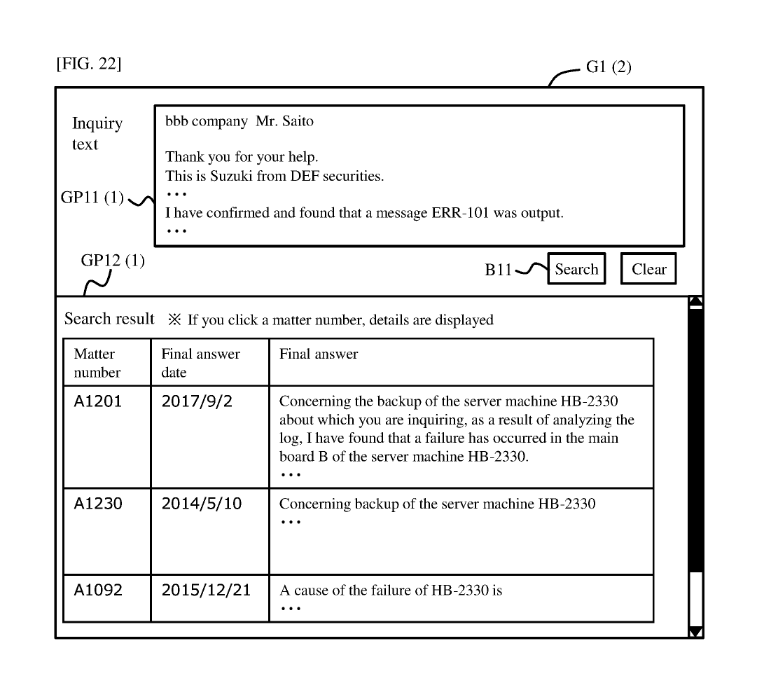

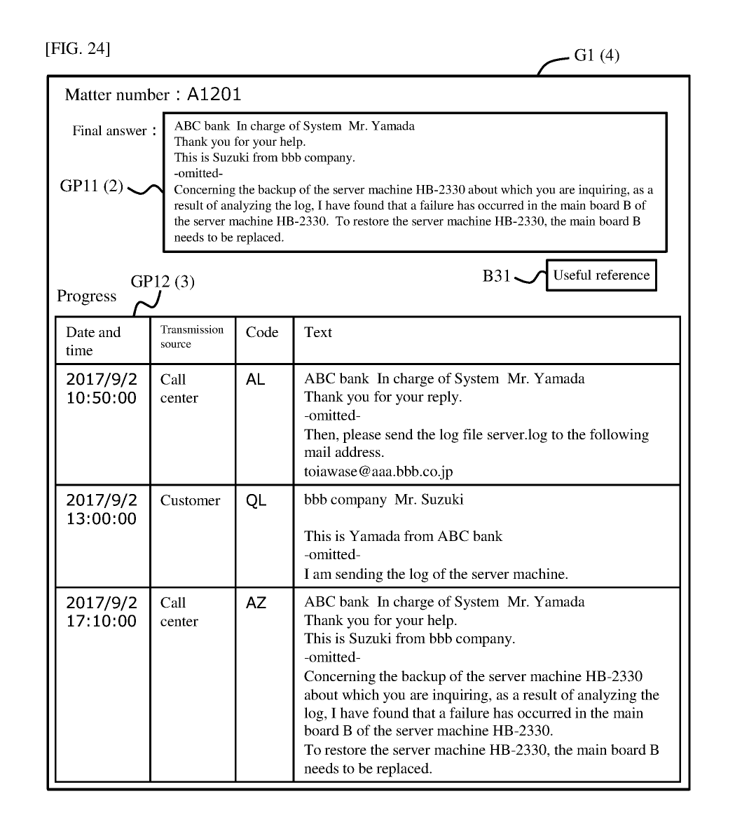

FIG. 22 shows an example after search of a case searching screen G1(2). The screen G1(2) after a search result includes, for example, an inquiry-text display section GP11(1), a search button B11, and a search result section GP12. When the person in charge selects a desired matter number, as shown in FIG. 23 or FIG. 24, detailed information is presented.

FIG. 23 shows an example of a detailed display screen G1(3) of the case searching screen. In this embodiment, after a list of search results is displayed on the screen G1(2) shown in FIG. 22, when the person in charge (the user) clicks a link set in the desired matter number, a detailed progress of the matter is displayed.

Instead of this, a detailed screen may be directly provided to the person in charge. That is, the person in charge does not need to perform operation for, for example, clicking a link. In this case, for example, the person in charge has to display only a highest-order matter of a search result.

The screen G1(3) shown in FIG. 23 includes, for example, a final answer section GP11(2) for displaying a final answer, a “useful reference” button B31, and a progress display section GP12(2). In the final answer section GP11(2), a final answer from the person in charge (a text of the code AZ) is displayed. Instead of this, an inquiry text from the customer may be displayed or the final answer section GP11(2) itself may be omitted from the screen.

In the progress display section GP12(2), all progresses may be displayed as shown in FIG. 23 or only a part of the progresses may be displayed as shown in FIG. 24.

In the screen G1(4) shown in FIG. 24, for example, a progress in or after date and time including a text coinciding most with an inquiry text used for search is displayed. In the examples shown in FIGS. 23 and 24, the code AL at “2017/9/1 10:50:00” corresponds to the progress. Because a part of the progresses is displayed, the person in charge can easily understand the next action that the person in charge should perform for the customer in response to an inquiry from the customer. In the case of FIGS. 23 and 24, the person in charge understand that an action to be performed next is to request the customer to send a log file (server.log). By automatically extracting the action to be performed next, the case searching system 1 can also be applied to an automatic response system.

According to this embodiment configured as explained above, the search query can be amended according to a predetermined conversation history corresponding to the search query. Therefore, according to this embodiment, the search query can be automatically supplemented using a conversation history. Efficiency of information search and convenience of use are improved.

According to this embodiment, the code information for classifying the content (handling content) of the conversation history for each of types is used. Therefore, the conversation history can be managed according to the content. The conversation history used for amendment of the search query can be easily extracted.

### Second Embodiment

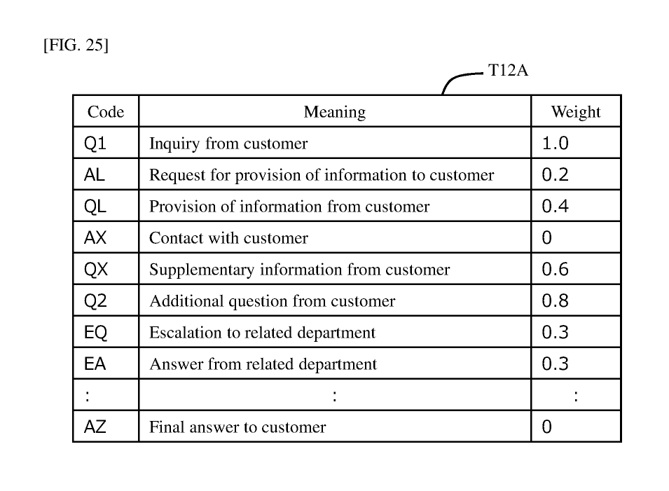

A second embodiment is explained with reference to FIGS. 25 to 27. Embodiments explained below including this embodiment are equivalent to modifications of the first embodiment. Therefore, differences from the first embodiment are mainly explained. In this embodiment, weight is given in advance to each of codes set in a conversation history. The weight is given to a search query to perform search.

FIG. 25 is a storage example of a handling-code storage unit T12A. The handling-code storage unit T12A stores a code, a meaning of the code, and weight of the code in association with one another.

Relatively high weight is set for information given from a customer and relatively low weight is set for information given from a person in charge to the customer. This is because the information (a text) given from the person in charge is considered to be not very useful for solution of a problem of the customer.

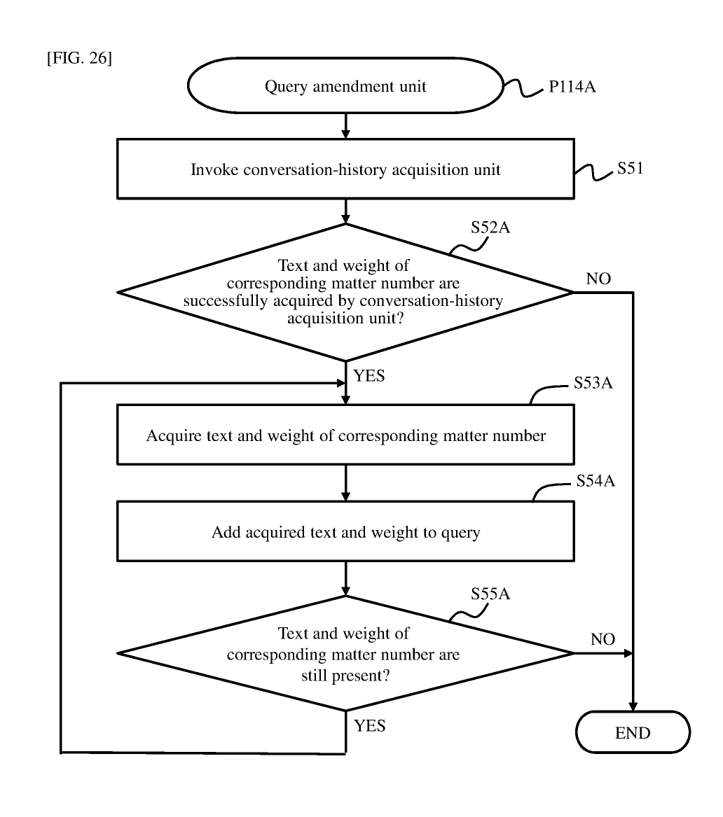

FIG. 26 is a flowchart for explaining processing of a query amendment unit P114A. The processing shown in FIG. 26 is different from the processing shown in FIG. 7 in that weight is acquired and added to a search query together with a text.

The query amendment unit P114A passes a matter number of an initial search query to the conversation-history acquisition unit P132 and invokes the conversation-history acquisition unit P132 (S51). The query amendment unit P114A determines whether the conversation-history acquisition unit P132 successfully acquires a conversation history and weight having the same matter number as the matter number of the initial search query (S52A).

If the conversation history having the corresponding matter number is successfully acquired by the conversation-history acquisition unit P132 (YES in S52A), the query amendment unit P114A acquire a text and weight of the conversation history having the corresponding matter number (S53A).

The query amendment unit P114A adds the text and the weight acquired in step S53A to the initial search query to thereby amend the initial search query (S54A). The query amendment unit P114A determines whether another text (and weight) having the corresponding matter number is still present (S55A). If the other text (and weight) is present (YES in S55A), the query amendment unit P114A returns to step S53A and further adds the other text to the search query (S54A).

If the conversation history having the corresponding matter number is not successfully acquired (NO in S52A) and if a text (the other text) of another conversation history having the corresponding matter number is absent (NO in S55A), this processing ends.

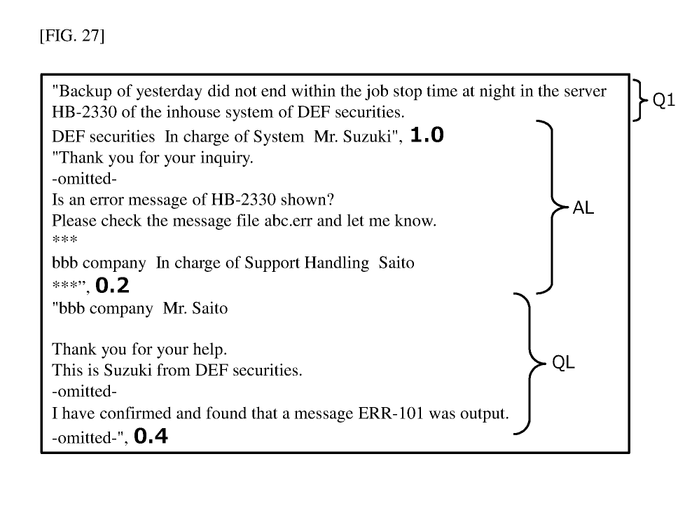

FIG. 27 shows an example of a search query after amendment. This embodiment is different from the first embodiment in that weight is given to each of codes in the search query. The weight can be reflected on search as explained below.

It is assumed that words and scores of the words (in parentheses) extracted from a text “Backup of yesterday did not end within the job stop time at night in the server HB-2330 of the inhouse system of DEF securities” to which a code Q1 is given are HB-2330 (100), backup (40), and did not end (10). In this case, by multiplying the extracted scores by weight “1.0” set for the code Q1, the scores of the words in this query are HB-2330 (100), backup (40), and did not end (10).

Similarly, it is assumed that words and scores of the words extracted from a text “Is an error message shown? Please check the message file abc.err and let me know. *** Saito, Support Service, bbb company ***” to which a code AL is given are error message (100), message file (30), check (20), and in charge (30). In this case, by multiplying the extracted scores by weight “0.2” set for the code AL, the scores of the words in this query change to HB-2330 (20), message file (6), check (4), and in charge (6). The same applies to a text to which a code QL is given.

In this embodiment, the scores are given to the words extracted from the document of the query after amendment in this way. A conversation history text is conceptually searched using the words with the scores. Note that when a word appears a plurality of times like the “HB-2330” described above, only a word having a highest score has to be left.

This embodiment configured as explained above has the same operational effects as the operational effects in the first embodiment. Further, according to this embodiment, because the weight can be given to each of the codes, the conversation history text can be conceptually searched preferentially using a keyword (a word) included in important handling. A more appropriate search result can be obtained and convenience of use is improved.

### Third Embodiment

A third embodiment is explained with reference to FIG. 28. A case searching system 1B of this embodiment is different from the case searching system 1 of the first embodiment in that the case searching system 1B performs the concept search on texts of conversation histories rather than performing the concept search on the conversation history text.

That is, in the first embodiment, the conversation history text is conceptually searched using the search query after amendment (the amended search query). However, a search target in this embodiment is texts of a conversation history. A conversation-history searching unit P115B of a case searching server 10B of this embodiment conceptually searches texts of conversation histories with the search query after amendment. The conversation-history searching unit P115B outputs a result of the search in matter number units. Processing of the result reranking unit P116 and the search-result display unit P112 is the same as the processing in the first embodiment.

This embodiment configured as explained above has the same operational effects as the operational effects in the first embodiment. In this embodiment, the texts of the conversation histories are directly conceptually searched without using a conversation history text obtained by coupling the texts of the conversation histories. Therefore, the configuration of the case searching server 10B can be simplified. This embodiment can be combined with the second embodiment and used.

### Fourth Embodiment

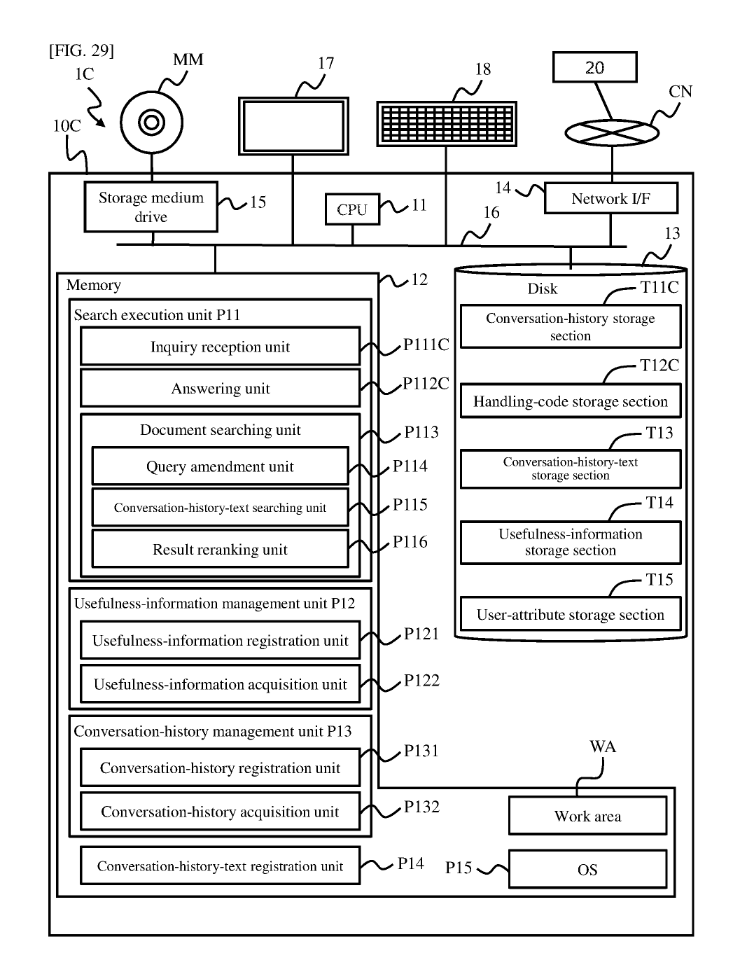

A fourth embodiment is explained with reference to FIGS. 29 to 31. In this embodiment, a case searching system 1C is applied to a chatbot system (a system for automatically responding to an inquiry).

FIG. 29 is a configuration example of the case searching system 1C. A case searching server 10C includes an inquiry reception unit P111C instead of the inquiry-text reception unit P111. Further, the case searching server 10C includes an answering unit P112C instead of the search-result display unit P112. In this embodiment, a person in charge in a call center does not answer an inquiry from a customer. Instead, the case searching system 1C functions as a chatbot and automatically answers the inquiry from the customer.

The inquiry reception unit P111C of this embodiment receives an inquiry from a customer. The answering unit P112C of this embodiment outputs, as a chat, a text of a code ZZ included in a highest-order matter number of a result of reranking by the result reranking unit P116.

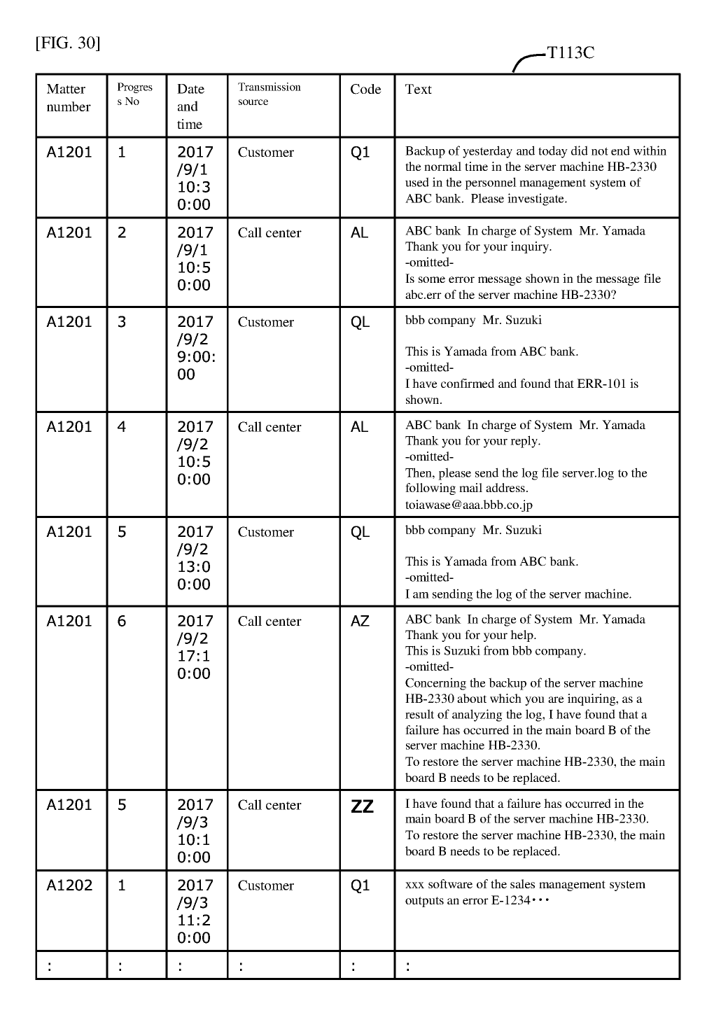

FIG. 30 shows an example of a conversation-history storage unit T11C. As indicated by thick characters in the lower side of FIG. 30, the code ZZ is a text created for an automatic answer on the basis of handling of a corresponding matter number. The text of the code ZZ is registered by a person in charge in a call center or a separately assigned answer creator by invoking the conversation-history registration unit P131 from the case searching system 1C.

The text of the code ZZ is created by excluding a customer name, a person in charge name, a greeting phrase, and the like from the text of the code AZ. Besides, the text of the code ZZ may be created anew for automatic response or may be cited from a manual or the like corresponding to the text.

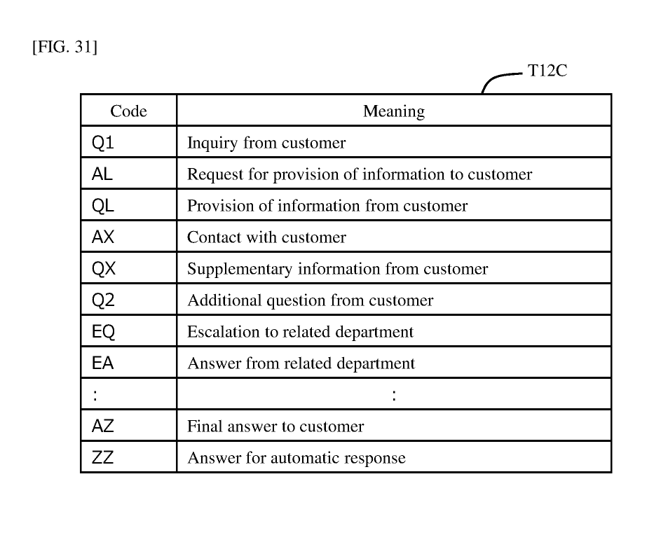

FIG. 31 shows an example of a handling-code storage unit T12C. The code ZZ indicates an answer for automatic response as explained above.

This embodiment configured as explained above has the same operational effects as the operational effects in the first embodiment. Further, according to this embodiment, the case searching system 1C can be incorporated in a chat system and can automatically answer an inquiry from a customer. Therefore, the case searching system 1C can be efficiently operated.

What is claimed is:

1. An information searching system that searching information, the information searching system comprising:
a conversation-history storage unit configured to store conversation histories for inquiries;
a conversation-history acquisition unit configured to acquire, from the conversation-history storage unit, a predetermined conversation history corresponding to a search query based on input information;
a search-query amendment unit configured to amend the search query on the basis of the predetermined conversation history; and
a searching unit configured to search, on the basis of the amended search query, the conversation histories stored in the conversation-history storage unit and output a search result.

2. The information searching system according to claim 1, wherein
the search query has a matter number given to each of inquiry matters,
the conversation-history storage unit is configured to associate the matter number and handling content in past to thereby store the matter number and the handling content as the conversation histories,
the conversation-history acquisition unit is configured to acquire a conversation history having a same matter number as the matter number of the search query from the conversation-history storage unit as the predetermined conversation history, and
the search-query amendment unit is configured to add at least a part of handling content included in the predetermined conversation history to the search query to thereby amend the search query.

3. The information searching system according to claim 2, wherein the conversation history includes code information for classifying the handling content for each of types.

4. The information searching system according to claim 3, wherein
weight information is set in the code information, and
the search-query amendment unit is configured to add handling content included in the predetermined conversation history to the search query on the basis of the weight information set for the handling content to thereby amend the search query.

5. The information searching system according to claim 1, further comprising:
a usefulness-information acquisition unit configured to acquire usefulness information indicating whether the conversation histories included in the search result are useful; and
a search-result rearrangement unit configured to rearrange order of the conversation histories included in the search result on the basis of the usefulness information.

6. The information searching system according to claim 5, wherein a value of the usefulness information is calculated according to attributes of a user who sets the usefulness information for the conversation histories.

7. The information searching system according to claim 2, wherein the searching unit is configured to set, as a search target, a conversation history text file obtained by collecting, as one file, conversation histories having a same matter number among the conversation histories stored in the conversation-history storage unit.

8. The information searching system according to claim 2, wherein the searching unit is configured to output, as the search result, a part of the conversation histories selected out of the conversation histories having the same matter number among the conversation histories stored in the conversation-history storage unit.

9. A method of searching information using a computer, the method comprising:
acquiring, from a conversation-history storage unit configured to store conversation histories for inquiries, a predetermined conversation history corresponding to a search query based on input information;
amending the search query on the basis of the acquired predetermined conversation history;
searching, on the basis of the amended search query, the conversation histories stored in the conversation-history storage unit; and
outputting a search result.
